(19) United States
(12) Patent Application Publication
(10) Pub. No.: US 2010/0043384 A1
(43) Pub. Date: Feb. 25, 2010

(54) Chain Link with a Locking Device

(75) Inventor: Uwe Kemper, Kreuztal (DE)

Correspondence Address: SMITH LAW OFFICE, 8000 EXCELSIOR DRIVE, SUITE 301, MADISON, WI, 53717, US

(73) Assignee: KABELSCHLEPP GMBH, Siegen (DE)

(21) Appl. No.: 12/086,325

(22) PCT Filed: Dec. 22, 2006
(86) PCT No.: PCT/EP2006/012504

§ 371 Date: Oct. 26, 2009

(30) Foreign Application Priority Data
Dec. 23, 2005 (DE) 10 2005 061 775.1

(51) Int. Cl. F16G 13/16

(52) U.S. Cl. 59/78.1

(57) ABSTRACT

The invention relates to a chain link of an energy drag chain for guiding cables, conduits and tubes between a stationary and a mobile point of connection, the chain link comprising two spaced-apart link plates. At least one of the link plates can be connected to at least one cross-piece in an articulated manner. Said cross-piece can be swiveled about at least one swivel axis between a closed position and an open position. The chain link comprises a detachable locking device by means of which the cross-piece can be fixed to at least one link plate. Said locking device comprises at least one elastic locking element which can be deflected at an angle to the longitudinal axis. The elastic locking element interacts with a support, the at least one locking element and the at least one support having an effective range in the closed position of the cross-piece which lies between the swivel axis of the cross-piece and an exterior of the link plate.

### FIELD AND BACKGROUND OF THE INVENTION

The object of the invention is concerned with a chain link of an energy drag chain.

Energy drag chains are used for guiding conduits, cables, tubes and similar between a stationary and a mobile point of connection. The energy drag chain is formed by a multiple number of chain links. The chains links are connected to one another in an articulated manner. Each chain link comprises two link plates and at least one cross piece that can be bound or is bound in an articulated manner to the link plates. The link plates and the cross pieces form a guide channel in which the conduits, tubes or similar are arranged.

Chain links are known which can be swiveled around only one swiveling axis on a link plate. Such a cross piece has on the opposite side a snap-action hook, which interacts with the link plate lying on the opposite side. Such an embodiment of a chain link is known for example from EP-A1-0 126 862.

WO 98/034050 describes a chain link that is formed by two link plates. The chain link has a cross piece, which is connected to the link plates in an articulated manner so that the cross piece can be separated from one or the other link plate and can be swiveled.

WO 00/063586 describes an energy drag chain for the guidance of cables, tubes and similar between a stationary and a mobile point of connection. The energy drag chain is constructed from a multiple number of chain links connected to one another in an articulated manner and made of plastic, each of which is formed from two side link plates and two cross pieces. At least one of the cross pieces is connected to the side link plates in a detachable manner. The cross piece has projections, which have positioning pins at their end regions that are directed perpendicularly to the cross piece. Two parallel slits are provided in the side link plates in which the projections of the cross piece engage. The slits have groove-like positioning points with back cuts so that the positioning pins can engage in these. A snap-in device is provided for securing the cross piece. The snap-in device has an elastically designed snap-action hook, which runs essentially perpendicular to the longitudinal direction of the link plate and parallel to this. The snap-action hook in the secured state engages in the cross piece in the middle between the projections through the intermediate space between the two projections, so that the hook is accessible manually.

Based on this, the task of the present invention is to further develop a chain link in such a way that simplified detachment of the cross piece is achieved.

### SUMMARY OF THE INVENTION

The chain link according to the invention of an energy drag chain for the guidance of cables, conduits, tubes between a stationary and a mobile point of connection has two link plates arranged at a distance to one another. At least one link plate can be connected to a cross piece in an articulated manner. The cross piece can be swiveled around at least one swiveling axis between a closed position and an open position. The chain link has a detachable locking device with the aid of which the cross piece can be secured on at least one link plate. The locking device has at least one elastic locking element which can be deflected perpendicular to the longitudinal axis. The locking element interacts with a support, whereby in the closed position of the cross piece, the at least one locking element and the at least one support have an effective range that lies between the swiveling axis of the cross piece and an outer side of the link plate.

Through this embodiment of the chain link according to the invention, simplified detachment of the cross piece is achieved. If the cross piece is joined to both link plates in an articulated manner, then, in contrast to the embodiment according to WO 00/063586, no additional force is required to detach the locking.

In order to ensure that unintended detachment of the cross piece does not occur, according to an advantageous embodiment of the chain link according to the invention it is proposed that the locking element be arranged in a window of the link plate. As a result of the fact that the locking element is arranged in a window of the link plate, a certain protection of the locking element is also achieved since the wall of the link plate covers the locking element partially.

According to an advantageous embodiment of the chain link it is proposed that the locking element have two end regions, each of which is connected to the link plate. The locking element extends essentially in the longitudinal direction of the link plate, whereby the deflection of the locking element occurs perpendicular to the plane of the link plate.

Preferably, the locking element has two elastic sections between which a holding section is arranged. The holding section works in connection with the support. The deflectability of the locking element is achieved by two elastic sections. It is also possible to have the locking element designed as a separate component, which is introduced into the link plate. Hereby, the link plate can have a corresponding recess and the locking element can be connected to the link plate in a positive or non-positive manner. The locking element can also be made in one piece with the link plate. Hereby preferably the design of the locking element is such that the locking element is made from a material different from the link plate material. Preferably the link plate and the locking element are produced by the two-component injection process.

The elastic locking element has two elastic sections. Preferably, at least one elastic section is designed to be bowed, especially wave-shaped.

According to a still further advantageous embodiment of the invention, it is proposed that the locking element be designed on the cross piece. The support is then designed on the link plate.

It is not absolutely necessary for the locking element to be designed on the link plate or on the cross piece. It is also possible to form a chain link such that one chain link plate has a locking element while the other chain link plate has the support, whereby the support is designed to be in one edge region of the cross piece and the elastic locking element on the other edge region of the cross piece.

If the at least one locking element is designed to be on the cross piece, then a preferred embodiment of the chain link is such that the locking element has end regions that are connected to the end region of the cross piece, whereby at least one section of the locking element is at a distance to a front face of the cross piece. With this design of the locking element, it is achieved that under the action of a force this can be moved in the direction of the end region of the cross piece. Due to the elasticity of the locking element, the locking element springs back into the original position when force is no longer acting on the locking element.

An embodiment of the chain link is preferred in which the locking element and/or the support is/are designed in a hook shape.

The locking element has a holding region, which interacts with the support so that opening or detachment of the cross piece can only occur when a force is applied to the locking element. In order to increase the force necessary for detaching the locking even further, the holding region and/or the support can be provided with a surface structure. The structure can be a microstructure or macrostructure. Mixtures of microstructures and macrostructures are also possible. The design of the chain link according to the invention makes possible the detachment of the cross piece from a link plate, whereby for swiveling of the cross piece minimal force is required, and the design of the locking device is chosen so that when the lockings are released it does not cause additional resistance.

Other advantages and details of the invention will be explained with the aid of the practical examples shown in the drawing, without the object of the invention being limited to these concrete practical examples.

### BRIEF DESCRIPTION OF THE DRAWINGS

FIG. 1 is a first practical example of a chain link in a top view,

FIG. 2 shows the chain link according to FIG. 1 in a side view,

FIG. 3 shows the chain link according to FIG. 1 in a front view,

FIG. 4 shows a cross piece of a chain link according to FIG. 1 in a top view,

FIG. 5 shows the cross piece according to FIG. 4 in a front view,

FIGS. 6 and 7 show the chain link with a cross piece in the closed position,

FIG. 8 shows the chain link with a cross piece in an open position,

FIG. 9 shows a second practical example of a chain link in a front view,

FIG. 10 shows the chain link according to FIG. 9 in a top view,

FIG. 11 shows a cross piece of the chain link according to FIG. 9 in a top view,

FIG. 12 shows the cross piece according to FIG. 11 in a front view and in a partial section,

FIG. 13 shows the cross piece according to FIG. 11 in a front view,

FIG. 14 shows the cross piece in the partial section and in a front view,

FIG. 15 shows the chain link with a cross piece in a closed position, and

FIG. 16 shows the chain link with a cross piece in the open position.

### DETAILED DESCRIPTION OF THE PREFERRED EMBODIMENTS

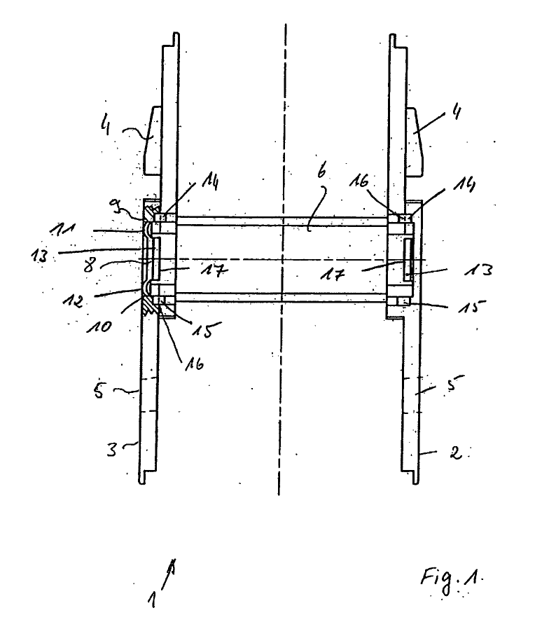

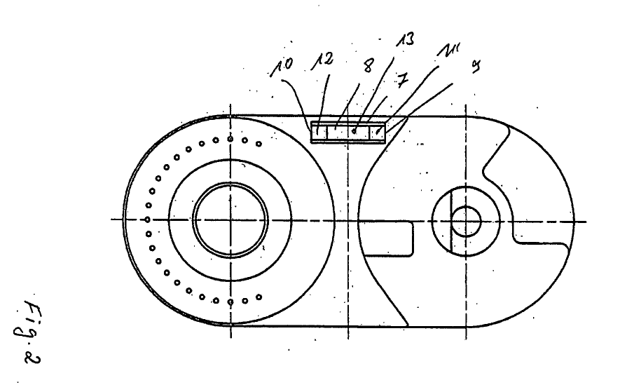

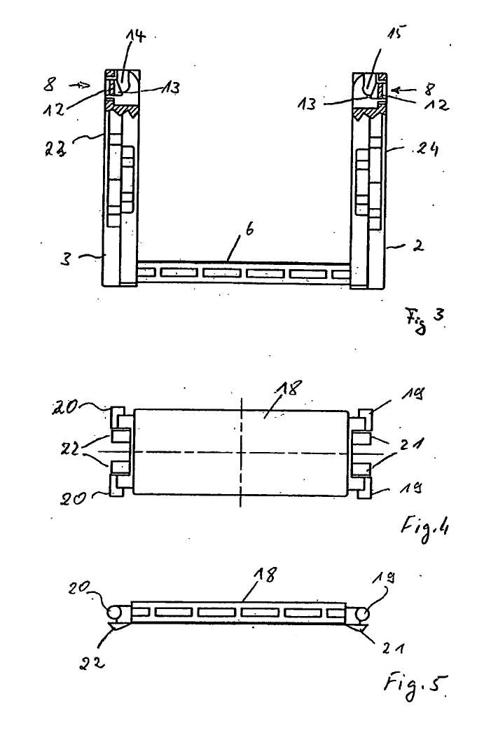

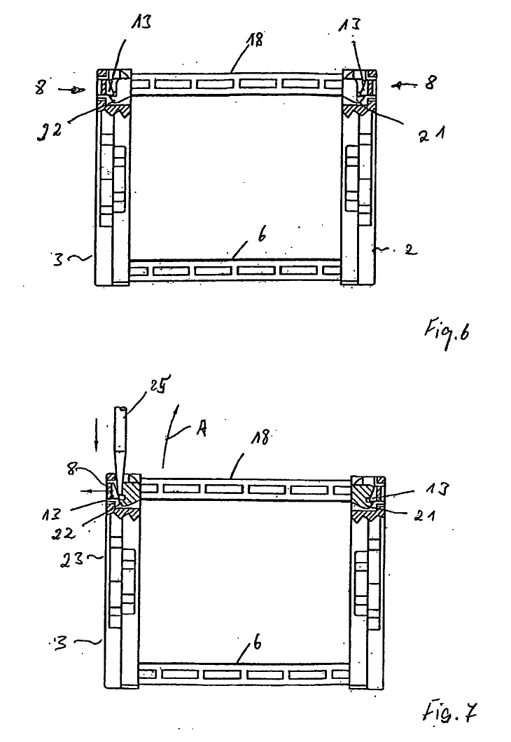

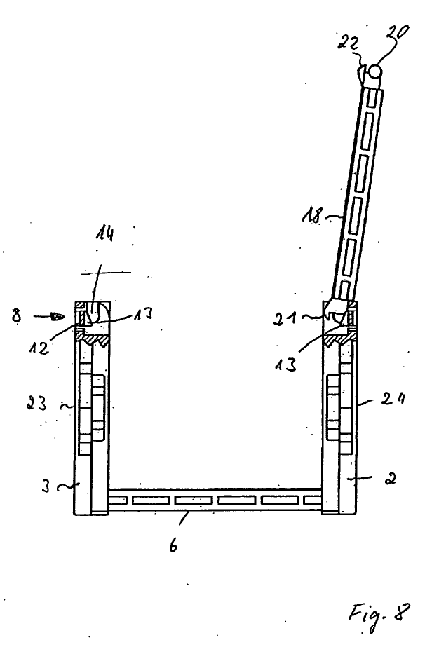

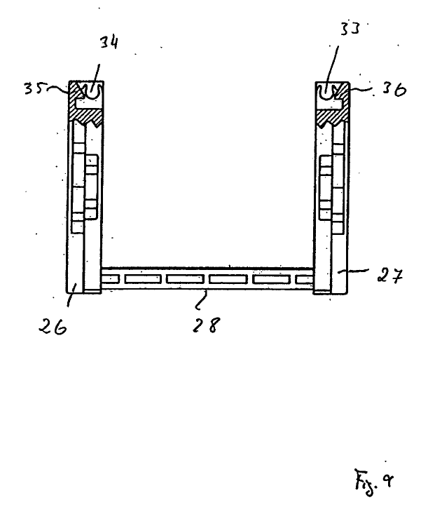

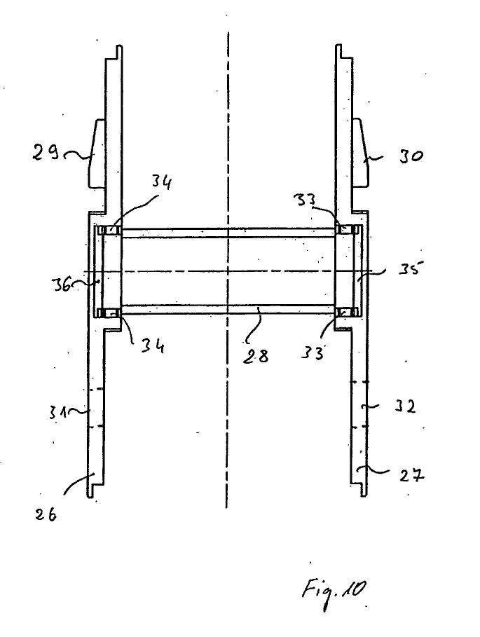

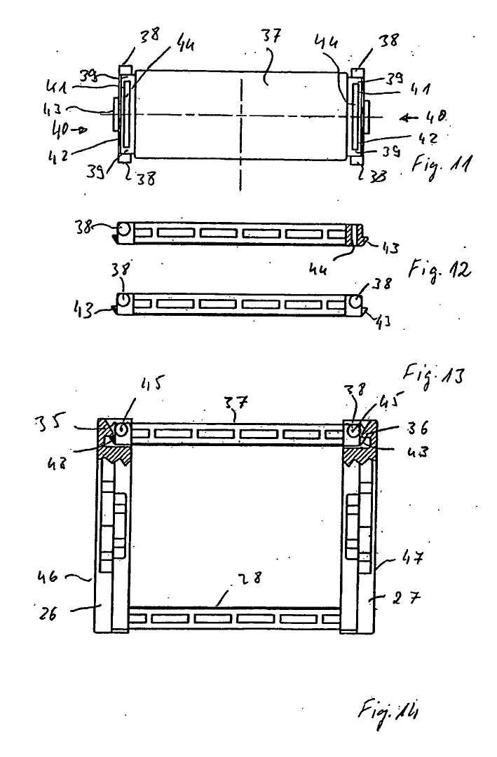

FIG. 1 shows a first practical example of a chain link of an energy drag chain for the guidance of cables, conduits, tubes and similar between a stationary and a mobile connecting point. The chain link 1 has two link plates 2, 3 at a distance from one another. Each link plate 2, 3 has a joint bolt 4 at one end. On the end region lying opposite, an articulated receptacle 5 is always provided, whereby the articulated receptacle 5 is designed so that a bolt 4 can be introduced into the articulated receptacle 5 so that neighboring members can be connected in an articulated manner. In order to limit the swiveling angle of two neighboring chain links, the link plates may have appropriate stops.

In the practical example shown, the link plates are joined together by an upper and lower cross piece. The representation according to FIG. 1 shows a chain link with a lower cross piece 6. For the sake of clarity, the upper cross piece is not shown. The link plates 2, 3 have a window 7 in which a locking element 8 is arranged. The locking element 8 has two end regions 9, 10 that are connected to the link plate.

In the practical example shown, the locking element 8 has two elastic sections 11, 12. The elastic sections 11, 12 are designed to be arc-shaped. A holding section 13 is formed between the elastic sections 11, 12. The locking element 8 within the window 7 is perpendicular to the longitudinal direction of the link plate can be swiveled out toward the outside. After the successful deflection of the locking element, it returns to its original position.

Each link plate has a recess that extends through a part of the height of the link plate to the opposite longitudinal edge. The recess has articulated receptacles 14, 15 into which the corresponding joint bolts of a cross piece can be introduced. These articulated receptacles 14, 15 are preferably designed so that a locking connection between the articulated receptacles 14, 15 and the joint bolts is achieved. Reference 16 denotes a swivel axis, around which a cross piece is swiveled when this is connected to one of the link plates. It can be seen from the representations according to FIG. 1 or FIG. 3 that the longitudinal edge 17 of the holding section 13 reaches at most to the swivel axis 16.

The holding section 13 is preferably designed to have a triangular cross section, whereby the holding section 13 widens downward as can be seen in FIG. 3.

FIGS. 4 and 5 show a cross piece 18 in a top view or in a front view. The cross piece 18 has pins 19, 20 at its end regions. The pins 19, 20 are designed so that these can be introduced into the articulated receptacle 14 or 15. The axes of pins 19, 20 are coaxial with the swivel axis 16, so that in order to open the chain link, the cross piece 18 can be swiveled around the swivel axis 16.

In the practical example shown, each end region of the cross piece 18 has supports 21, 22. Each support has a lead-in slope, which interacts with the holding section so that when the chain link is closed, the locking element is deflected to the outside 23 of link plate 3 or to the outside 24 of link plate 2 and essentially perpendicular to the longitudinal direction of the chain link.

FIG. 6 shows the chain link according to the invention of an energy drag chain for guiding cables, conduits, tubes and similar between stationary and a mobile point of connection in the closed state. It can be seen from the representation of FIG. 6 that the holding section 13 of the locking element 8 interacts with the support 21 or 22, so that the cross piece 18 is connected to the link plates 2, 3 separably. In the practical example shown, the separable connection of the cross piece 18 with the link plate 2 and/or link plate 3 can be separated. In order to swivel the cross piece 18, for example around the swivel axis 16 of link plate 2, the connection between the cross piece 18 and the link plate 3 is detached. For this purpose a tool 25 (FIG. 7), which can be for example a screwdriver, is introduced between the locking element 8 and the end region of the cross piece 18 in such a way that the locking element 8 is moved toward the outside, that is, in the direction of outside 23. By the movement of the locking element 8, the connection between the holding section 13 and the support 22 is released, so that the cross piece 18 can be swiveled around the swivel axis 16 on the link plate, as indicated by arrow A.

The locking element 8 and the support 21 or 22 have an effective range that lies between the swivel axis 16 and an outer side 23 or 24, so that no additional force is required to swivel the crosspiece 18, in order to overcome the working connection between the locking element and the support on the other link plate. FIG. 8 shows the chain link according to FIG. 7 in the open position of cross piece 18.

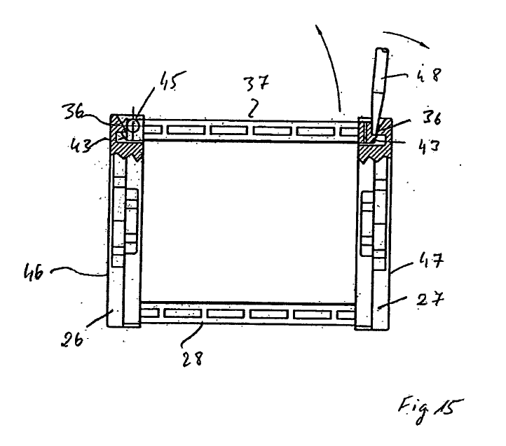

FIGS. 9 to 16 show second practical example of a chain link according to the invention.

The chain link is formed by two link plates 26, 27 arranged at a distance from one another. The chain link plates 26, 27 are connected to one another via a lower cross piece 28. At the one end region of link plates 26, 27 joint bolts 29, 30 are arranged. At the end regions lying opposite, articulated receptacles 31, 32 are arranged, into which the joint bolts on the neighboring chain link can be introduced, so that a majority of chain links become joined together in an articulated manner, which forms an energy drag chain to guide cables, conduits and tubes and the like between a fixed and a mobile connection point. From the illustration in FIG. 9 and FIG. 10 one can see that recesses are provided in the longitudinal edge of the link plate. Articulated receptacles 33, 34 are provided into which the corresponding pins of a cross piece can be introduced. On both sides of the articulated receptacles 33, 34, a support 35, 36 is always provided, which is essentially hook-shaped. The cross piece 37 has extensions 39, that extend in the longitudinal direction of the cross piece 37. The extensions 39 are provided next to the longitudinal edges of the cross piece. Pins 38 are formed on the extensions 39. The shape of the pins 38 is chosen so that these can be introduced into the articulated receptacles 33, 34 and be are swivelable in these articulated receptacles.

A locking element 40 is connected to the extensions 39. The locking element 40 has two elastic sections 41, 42. A holding section 43 is formed between the elastic sections 41, 42. The locking element is designed so that it can be moved in the direction of the front face of the cross piece 37. In each case a window 44 is formed between the locking element 40 and the front face of the cross piece 37.

The pins 38 are introduced into the articulated receptacles 33, 34 in order to connect the cross piece 37 with the link plates 25, 26. By pressing down the cross piece in the direction of the lower cross piece 28, the locking elements 40 slide on the slanted surfaces of supports 35, 36 so that the locking elements 40 are pressed in the direction of the front faces of the cross piece 37 until the locking elements 40 reach below the supports 35 or 36 with their holding sections 43.

It can be seen from FIG. 14 that the locking element or the holding section 43 with the support 35 forms a working area, which lies between a swiveling axis 45 and an outside 46 of the link plate 26 or of the outside 47 of the link plate 25.

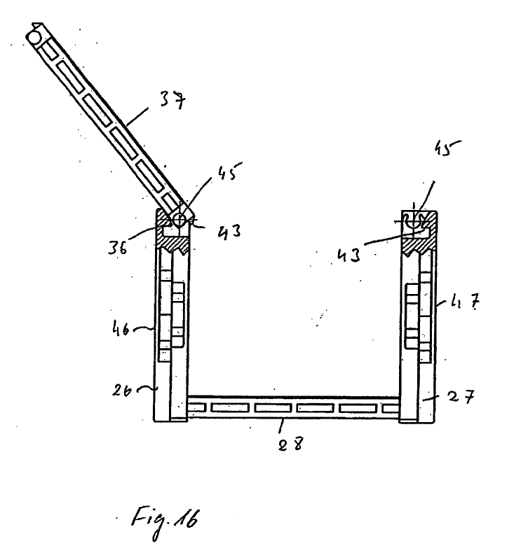

In order to open the cross piece 37, a tool 48, especially a screwdriver is introduced into the area between the locking element 40 and the support 36, as shown in FIG. 15. By swiveling the tool 48 in the direction of the outside 47, the locking element 40 is moved in the direction of the front face of the cross piece 37 so that the holding section 43 is brought out of contact with the support 36. The cross piece 37 can then be swiveled around the swiveling axis 45 on the link plate 26. The embodiment shown makes it possible to open the cross piece as desired. FIG. 16 shows the chain link according to the invention in the open position.

In the chain link according to the invention, both cross pieces can be connected separably to the link plates. It is also possible for a cross piece to be is designed so that it can be swiveled only around one swivel axis. In such an embodiment, a mounting can be present on the opposite end region of the cross piece, for example in the form of a hook, which can be connected to the corresponding link plate.

1. A chain link for an energy drag chain for the guidance of cables, conduits, tubes and similar elements, between a stationary and a mobile connecting point, the chain link comprising:
a first link plate;
a second link plate spaced apart from the first link plate; and
a cross piece releasably joined to the first link plate when in a closed position and pivotable about a swivel axis on the second link plate when in an open position;
wherein the first link plate comprises a locking element having an elastic section; and
wherein the cross piece comprises a support joined to the cross piece that releasably engages the elastic section of the locking element.

2. The chain link of claim 1, wherein the locking element is arranged in a window defined by the first link plate.

3. (canceled)

4. (canceled)

5. (canceled)

6. (canceled)

7. (canceled)

8. (canceled)

9. The chain link of claim 1, wherein the locking element has two end regions, each of which is connected to the first link plate.

10. The chain link of claim 1, and wherein the locking element further comprises:
a second elastic section; and
a holding section joined to and disposed between the two elastic sections.

11. The chain link according of claim 10, wherein each elastic section is substantially arc-shaped.

12. A chain link for an energy drag chain for the guidance of cables, conduits, tubes and similar elements, between a stationary and a mobile connecting point, the chain link comprising:
a first link plate;
a second link plate spaced apart from the first link plate; and
a cross piece releasably joined to the first link plate when in a closed position and pivotable about a swivel axis on the second link plate when in an open position;
wherein the cross piece comprises a locking element having an elastic section; and
wherein the first link plate comprises a support joined to the cross piece that releasably engages the elastic section of the locking element.

13. The chain link of claim 12, wherein the locking element extends outwardly from an end region of the cross piece.

14. The chain link of claim 1, wherein the elastic section is substantially hook-shaped.

15. The chain link of claim 1, wherein the support is substantially hook-shaped.

16. The chain link of claim 1, wherein the elastic section and the support are each substantially hook-shaped.
